(19) United States
(12) Patent Application Publication
(10) Pub. No.: US 2020/0257034 A1
(43) Pub. Date: Aug. 13, 2020

(54) LIGHT GUIDE PLATE, LIGHT GUIDE AND VIRTUAL IMAGE DISPLAY DEVICE

(71) Applicant: SHARP KABUSHIKI KAISHA, Sakai City, Osaka (JP)

(72) Inventor: TAKESHI MASUDA, Sakai City (JP)

(21) Appl. No.: 15/780,822

(22) PCT Filed: Nov. 15, 2016
(86) PCT No.: PCT/JP2016/083840

§ 371 Date: Jun. 1, 2018

(30) Foreign Application Priority Data
Dec. 3, 2015 (JP) 2015-236221

(51) Int. Cl. F21V 8/00; G02B 27/30; G02B 27/01

(52) U.S. Cl. CPC G02B 6/0036; G02B 27/0101; G02B 27/30; G02B 6/0025

(57) ABSTRACT

A light guide plate (30) includes: a light-guiding layer (33) having a first light-guiding layer (33A), the first light-guiding layer including a prism reflection array (35) which is constructed so as to partially transmit a light beam propagating therein, and a second light-guiding layer (33B) covering the prism reflection array; an outgoing surface (S1) via which the light beam transmitted through the prism reflection array is allowed to exit; and at least one supporting body (35C) having, along the normal direction of the outgoing surface, a height which is greater than the height of the prism reflection array.

### TECHNICAL FIELD

This disclosure relates to a light guide plate, a lightguide, and a virtual image display apparatus.

### BACKGROUND ART

In recent years, virtual image display apparatuses have been being developed which magnify and display images, formed by a small-size display element, as virtual images. Virtual image display apparatuses include, for example, head-mounted displays (hereinafter referred to as “HMDs”) and head-up displays (hereinafter referred to as “HUDs”). A virtual image display apparatus is constructed so as to project light, which has been emitted by a display element, in the direction of a viewer's eye by using a light guide plate, a combiner, etc. A virtual image display apparatus of the see-through type is able to display virtual images of images formed by the display element, such that they are superposed on the landscape of the exterior as is visible through the light guide plate and the combiner. Using such a virtual image display apparatus allows to easily provide an AR (Augmented Reality) environment.

Patent Document 1 discloses a virtual image display apparatus of the see-through type which includes an optical system, a coupling member, and a light-guiding member having a diffraction grating. By using a series of lenses, the optical system collimates displaying light from a display element into beams of parallel light (collimated light), so as to create a virtual image. The collimated light having been introduced into the light-guiding member via the coupling member, which is disposed on the light-guiding member, propagates through the interior of the light-guiding member by repeating total reflections, and reflects off the diffraction grating therein so as to exit from the light-guiding member to the exterior. The outgoing light beams reach a viewer's pupil. The light-guiding member is constructed by forming semi-reflective films on slope surfaces of a sawtooth diffraction grating, which are molded using a transparent material, and further by covering the diffraction grating with a transparent material which is equal in refractive index to the aforementioned transparent material. The reflectances of the semi-reflective films may be constant regardless of their positions, or alternatively, vary so as to increase away from the optical system. Such a construction allows to thin down the thickness of the light-guiding member and also to inexpensively produce the light-guiding member.

### CITATION LIST

### Patent Literature

Patent Document 1: Japanese Laid-Open Patent Publication No. 2004-157520

### SUMMARY OF INVENTION

### Technical Problem

However, a study by the inventor has found that, in the light-guiding member, an outgoing surface through which the collimated light from the optical system exits and an opposite surface which is opposite from the outgoing surface are required to align parallel and also to be each flat. One possible way of achieving this is, for example, to press the transparent material covering the diffraction grating, which has the semi-reflective films formed thereon, down toward the diffraction grating. In this manner, in the transparent material covering the diffraction grating, the face (i.e., the aforementioned opposite surface) that is opposite from a face contacting the diffraction grating surface may be flattened, and also the opposite surface may be aligned parallel to the outgoing surface. However, down-pressing the transparent material might possibly deform the apices of the diffraction grating, or might possibly crack the semi-reflective films around the apices. This may well be a factor causing scattering of the light beams. As a result, the collimated light is scattered inside the light-guiding member, thereby blurring the virtual image to be projected onto the viewer's eye.

The present disclosure has been made in order to solve the above problem, and an objective thereof is to provide a light guide plate, a lightguide, and a virtual image display apparatus incorporating the same, which are able to reduce blurring of virtual images to be projected onto a viewer's eye.

### Solution to Problem

A light guide plate according to an embodiment of the present invention comprises: a light-guiding layer having a first light-guiding layer, the first light-guiding layer including a prism reflection array which is constructed so as to partially transmit a light beam propagating therein, and a second light-guiding layer covering the prism reflection array; an outgoing surface via which the light beam transmitted through the prism reflection array is allowed to exit; and at least one supporting body having, along a normal direction of the outgoing surface, a height which is greater than a height of the prism reflection array.

In one embodiment, the at least one supporting body may be disposed in surroundings of the prism reflection array.

In one embodiment, the prism reflection array may have a plurality of prisms arranged along a first direction in a plane which is parallel to the outgoing surface, each prism extending along a second direction which is orthogonal to the first direction, the at least one supporting body extending along the second direction.

In one embodiment, the prism reflection array may have a plurality of prisms arranged along a first direction in a parallel plane which is parallel to the outgoing surface, each prism extending along a second direction which is orthogonal to the first direction, the at least one supporting body extending along the first direction.

In one embodiment, the at least one supporting body may comprise a plurality of supporting bodies; and the plurality of supporting bodies may be arranged in a dot pattern.

In one embodiment, the prism reflection array may have a plurality of first and a plurality of second slope surfaces inclined with respect to the outgoing surface, the plurality of first slope surfaces being coated with semi-reflective films which partially reflect a light beam propagating inside the light-guiding layer and which also partially transmit the light beam, the plurality of second slope surfaces not being coated with any semi-reflective films.

In one embodiment, each of the plurality of supporting bodies may be dome-shaped.

In one embodiment, the first light-guiding layer may include the at least one supporting body together with the prism reflection array.

In one embodiment, the light-guiding layer may further have a third light-guiding layer that includes the at least one supporting body.

In one embodiment, the at least one supporting body and the prism reflection array may be formed as an integral piece.

In one embodiment, the at least one supporting body may be formed independently from the prism reflection array.

In one embodiment, the at least one supporting body may comprise a plurality of spacers defining a thickness of the light-guiding layer along the normal direction.

In one embodiment, the second light-guiding layer may have an essentially flat surface.

One embodiment may further comprise a first transparent substrate supporting the first light-guiding layer and a second transparent substrate supporting the second light-guiding layer.

A lightguide according to an embodiment of the present invention comprises: a coupling structure having a light-receiving surface to receive a light beam from a display element; and any of the above light guide plates.

A virtual image display apparatus according to an embodiment of the present invention comprises: a display element; a collimating optical system to collimate displaying light emitted from the display element; and the above lightguide.

### Advantageous Effects of Invention

According to the present invention, there are provided a light guide plate, lightguide, and a virtual image display apparatus incorporating the same, which are able to reduce blurring of virtual images to be projected onto a viewer's eye.

### BRIEF DESCRIPTION OF DRAWINGS

FIG. 1A is a perspective view schematically illustrating the construction of a virtual image display apparatus 100 according to a first embodiment.

FIG. 1B is a plan view of the virtual image display apparatus 100 according to the first embodiment.

FIG. 2 is a cross-sectional view of a light guide plate 30 according to the first embodiment, as taken parallel to the XZ plane, schematically illustrating an internal structure of the light guide plate 30.

FIG. 3 is a cross-sectional view of one of a plurality of optical prisms 35A in a prism reflection array 35, as taken parallel to the XZ plane.

FIG. 4 is a cross-sectional view of the light guide plate 30 as taken parallel to the XZ plane, schematically illustrating an internal structure of a first light-guiding layer 33A.

FIG. 5A is a schematic diagram illustrating an exemplary array pattern of a plurality of optical prisms 35A in a closer region and a farther region relative to a coupling structure 32.

FIG. 5B is a schematic diagram illustrating an exemplary array pattern of a plurality of optical prisms 35A in a closer region and a farther region relative to a coupling structure 32.

FIG. 5C is a schematic diagram illustrating an exemplary array pattern of a plurality of optical prisms 35A in a closer region and a farther region relative to a coupling structure 32.

FIG. 6 is a cross-sectional view of a light guide plate 30 in the XZ plane, for describing behavior of propagating light L2.

FIG. 7 is a schematic diagram illustrating how semi-reflective films 35r may be formed on a prism reflection array 35 through oblique vapor deposition.

FIG. 8 is an external view of a mask 50 which is used so that the semi-reflective films 35r are vapor-deposited exclusively onto predetermined surfaces of the optical prisms 35A.

FIG. 9 is a schematic diagram illustrating how, after a second transparent material which has been applied over the prism reflection array 35 is pressed under a quartz substrate 38 for pressurized filling, the second transparent material may be cured by polymerization through UV irradiation.

FIG. 10 is a plan view of a virtual image display apparatus 100 according to a second embodiment.

FIG. 11 is a cross-sectional view of a light guide plate 30A according to the second embodiment, as taken parallel to the XZ plane, schematically illustrating an internal structure of the light guide plate 30A.

FIG. 12 is a side view of the light guide plate 30A according to the second embodiment, as viewed along the X direction.

FIG. 13 is a cross-sectional view of the light guide plate 30A as taken parallel to the XZ plane, schematically illustrating an internal structure of a first light-guiding layer 33A which is supported by a first transparent substrate 34A.

FIG. 14 is a cross-sectional view of one of a plurality of optical prisms 35A in a prism reflection array 35, as taken parallel to the XZ plane.

FIG. 15 is a cross-sectional view of a light guide plate 30A according to the second embodiment, as taken parallel to the YZ plane, schematically illustrating an internal structure of the light guide plate 30A.

FIG. 16 is a schematic diagram illustrating how semi-reflective films 35r may be formed on a prism reflection array 35 through oblique vapor deposition.

FIG. 17 is an external view of a mask 50 which is used so that the semi-reflective films 35r are vapor-deposited exclusively onto predetermined surfaces of the optical prisms 35A.

FIG. 18 is a schematic diagram illustrating how, after a second transparent material which has been applied over the prism reflection array 35 is pressed with a quartz substrate 38 for pressurized filling, the second transparent material may be cured by polymerization through UV irradiation.

FIG. 19 is a schematic diagram illustrating how, after a second transparent material which has been applied over a plurality of supporting prisms 35C is pressed with a quartz substrate 38 for pressurized filling, the second transparent material may be cured by polymerization through UV irradiation.

FIG. 20 is a plan view of a virtual image display apparatus 100 according to a third embodiment.

FIG. 21 is a cross-sectional view of a light guide plate 30B according to the third embodiment, as taken parallel to the XZ plane, schematically illustrating an internal structure of the light guide plate 30B.

FIG. 22 is a side view of the light guide plate 30B according to the third embodiment, as viewed along the X direction.

FIG. 23 is a cross-sectional view of the light guide plate 30 according to the third embodiment, as taken parallel to the YZ plane, schematically illustrating an internal structure of the third light-guiding layer 33C.

FIG. 24 is a schematic diagram illustrating how, after a second transparent material which has been applied over the prism reflection array 35 is pressed with a quartz substrate 38 for pressurized filling, the second transparent material may be cured by polymerization through UV irradiation.

FIG. 25 is a schematic diagram illustrating how, after a second transparent material which has been applied over a plurality of supporting prisms 35C is pressed with a quartz substrate 38 for pressurized filling, the second transparent material may be cured by polymerization through UV irradiation.

### DESCRIPTION OF EMBODIMENTS

Hereinafter, with reference to the drawings, light guide plates and lightguides according to embodiments of the present invention, and virtual image display apparatuses incorporating the same will be described. In the following description, identical or similar constituent elements have like reference numerals. Although the construction of an HMD will be described as an exemplary virtual image display apparatus, embodiments of the present invention are not limited thereto; they are also applicable to other implementations of virtual image display apparatuses such as HUDs, etc., for example. Moreover, it would also be possible to combine one embodiment with another.

A light guide plate according to an embodiment of the present invention includes: a light-guiding layer having a first light-guiding layer, the first light-guiding layer including a prism reflection array which is constructed so as to partially transmit a light beam propagating therein, and a second light-guiding layer covering the prism reflection array; an outgoing surface via which the light beam transmitted through the prism reflection array is allowed to exit; and at least one supporting body having, along the normal direction of the outgoing surface, a height which is greater than the height of the prism reflection array. Preferably, the refractive index of the first light-guiding layer is substantially equal to that of the second light-guiding layer.

According to embodiments of the present invention, by providing a supporting body the height of which is higher than that of the prism reflection array, deformation or destruction of the prism reflection array which may occur especially during production can be avoided. As a result, it is possible to reduce scattering of light inside the light guide plate and thus to reduce blurring of virtual images to be projected onto a viewer's eye.

### First Embodiment

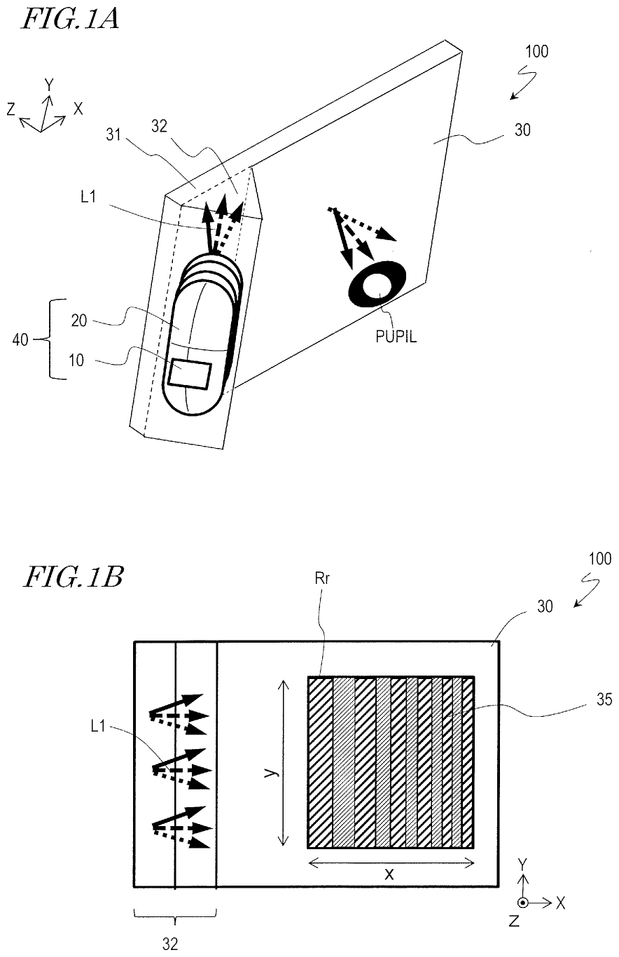

FIG. 1A is a perspective view schematically illustrating the construction of a virtual image display apparatus 100 according to a first embodiment. FIG. 1B is a plan view of the virtual image display apparatus 100.

The virtual image display apparatus 100 includes a display element 10, a projection lens system (collimating optical system) 20 which receives light emitted from the display element 10 and collimates it, a coupling structure 32 to receive the collimated light, and a light guide plate 30 with which to project toward a viewer the collimated light from the coupling structure 32.

At an end of one principal face of the light guide plate 30, the coupling structure 32 is provided, the coupling structure 32 having a light-receiving surface which receives collimated light L1 from the projection lens system 20. The present embodiment uses as the coupling structure 32 a triangular prism extending along an edge of the light guide plate 30 (i.e., along the Y direction shown in FIG. 1B). In the present specification, an optical element including the light guide plate 30 and the coupling structure 32 may be referred to as a “lightguide”. On the other hand, a device including the display element 10 and the projection lens system 20 may be referred to as a “virtual image projection device 40”.

The light guide plate 30 includes a prism reflection array 35 which partially reflects the collimated light propagating through the interior so that it goes out to the exterior. For example, the light guide plate 30 is 55 mm in width along the X direction and 30 mm in width along the Y direction, while the lightguide except for the coupling structure 32, i.e. the light guide plate 30, is 2.2 mm in thickness along the Z direction. On the other hand, as illustrated in FIG. 1B, the prism reflection array 35 is disposed in a predetermined in-plane region that is within a plane parallel to an outgoing surface through which light is extracted. In the present embodiment, the prism reflection array 35 is disposed in a predetermined rectangular region Rr which has a width x along the X direction and a width y along the Y direction within the plane of the light guide plate 30.

The light-receiving surface of the coupling structure 32 is inclined with respect to the outgoing surface of the light guide plate 30 through which a light beam is allowed to exit. The optical axis of the virtual image projection device 40, i.e. the optical axis of the projection lens system 20, is adjusted so as to be orthogonal to the light-receiving surface of the coupling structure 32, for example.

In the virtual image display apparatus 100, the emission light (i.e., virtual image displaying light) from the display element 10 is collimated by the projection lens system 20, and then enters the coupling structure 32 disposed at the end of the light guide plate 30. The collimated light L1 having entered the coupling structure 32 propagates, while repeating total reflections, through the interior of the light guide plate 30 from a light receiving portion 31 of the light guide plate 30, which is the portion at which the coupling structure 32 is disposed, for example along the X direction shown in FIG. 1B (i.e., in an in-plane direction from the coupling structure 32 toward the opposing edge of the light guide plate 30).

The collimated light L1 to be introduced from the coupling structure 32 into the light guide plate 30 contains, as illustrated in FIG. 1A and FIG. 1B, a plurality of light beams having different directions of travel according to pixel positions on the display element 10. For example, a light beam emitted from the central region of the display element 10 corresponds to a light beam traveling in a direction that is parallel to the X direction shown in FIG. 1B, whereas a light beam emitted from a peripheral region of the display element 10 corresponds to a light beam traveling in a direction non-parallel to the X direction.

As the display element 10 and the projection lens system 20, those which are known can be broadly used. For example, a transmission type liquid crystal display panel or an organic EL display panel may be used as the display element 10, while a lens system which is disclosed in e.g. Japanese Laid-Open Patent Publication No. 2004-157520 may be used as the projection lens system 20. Alternatively, a reflection type liquid crystal display panel (LCOS) may be used as the display element 10, while concave mirrors or lenses disclosed in e.g. Japanese Laid-Open Patent Publication No. 2010-282231 may be used as the projection lens system 20. The entire disclosures of Japanese Laid-Open Patent Publication No. 2004-157520 and Japanese Laid-Open Patent Publication No. 2010-282231 are incorporated herein by reference.

The display element 10 is about 0.2 inches to about 0.5 inches diagonal, for example. Note that the diameter of a light beam to be emitted from the projection lens system 20 may be adjusted by the projection lens system 20. On the other hand, the size of a light beam to enter the light guide plate 30 is determined by the size of the coupling structure 32.

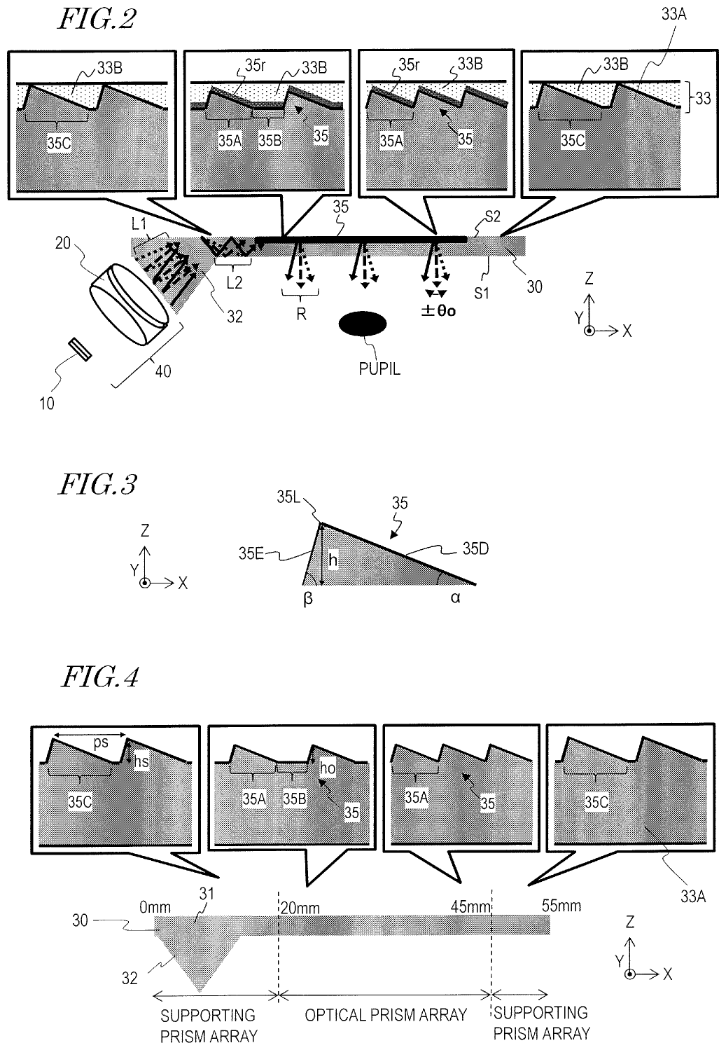

FIG. 2 schematically illustrates a cross section as taken parallel to the XZ plane, which mainly illustrates the internal structure of the light guide plate 30. FIG. 3 schematically illustrates an enlarged cross section of one of a plurality of optical prisms 35A in the prism reflection array 35, as taken parallel to the XZ plane.

The light guide plate 30 includes: a light-guiding layer 33 having the prism reflection array 35; an outgoing surface S1 via which a light beam transmitted through the prism reflection array 35 is allowed to exit; and a plurality of supporting prisms 35C. The coupling structure 32 is disposed on the outgoing surface of the light guide plate 30, at a side closer to the light receiving portion 31 (see FIG. 1A). However, the coupling structure 32 may alternatively be disposed on an upper principal face S2 described later, which is opposite from the outgoing surface S1 in the light guide plate 30.

The light-guiding layer 33 includes: a first light-guiding layer 33A having the prism reflection array 35; and a second light-guiding layer 33B covering the prism reflection array 35. The prism reflection array 35 is constructed so as to partially transmit a light beam being incident through the coupling structure 32 and propagating therein. Preferably, the refractive index of the first light-guiding layer 33A is substantially equal to that of the second light-guiding layer 33B, and preferably, the first light-guiding layer 33A and the second light-guiding layer 33B are made of an identical material. The thickness of the light-guiding layer 33 is chosen to be 0.1 mm to 0.5 mm, for example.

Along the normal direction (i.e., the Z direction in the drawing) of the outgoing surface S1, the height of the supporting prisms 35C is greater than that of the prism reflection array 35 (the optical prisms 35A). The relationship in height between the prisms will be described in detail later.

The outer surface of the second light-guiding layer 33B constitutes the upper (i.e., opposite side from the viewer) principal face S2 of the light guide plate 30. The outgoing surface S1 corresponds to a lower principal face S1 of the light guide plate 30. The lower principal face S1 and the upper principal face S2 of the light guide plate 30 are exposed to air. In the present specification, the principal faces of the light guide plate 30 may respectively be referred to as the upper principal face S2 and the lower principal face S1 according to the drawing, for convenience of distinction. However, it should be appreciated that they do not imply an upper-lower relative positioning in actual use.

In the present embodiment, the plurality of optical prisms 35A constituting the prism reflection array 35 and the plurality of supporting prisms 35C are formed in the same first light-guiding layer 33A, and also arranged along the same direction (the X direction).

The optical prisms 35A are triangular prisms extending along the Y direction in a plane which is parallel to the outgoing surface S1. The prism reflection array 35 has the plurality of optical prisms 35A being arranged along the X direction, which is orthogonal to the Y direction. Note that, as will be described later, a slit-like flat portion (hereinafter referred to as a “parallel surface”) 35B may be provided between two adjacent optical prisms 35A.

An optical prism 35A includes a slope surface coated with a semi-reflective film 35r, so as to exert optical effects on a light beam. The semi-reflective film 35r is made of e.g. a thin metal film (an Ag film, Al film, etc.) or a dielectric film (a TiO₂ film, etc.), and thus capable of partially reflecting an incident light beam and partially transmitting the light beam. The prism reflection array 35 mainly denotes an array of semi-reflective films 35r on the interface between the first and second light-guiding layers 33A and 33B. The film thickness of a semi-reflective film 35r generally ranges from several nm to several hundred nm. The prism reflection array 35 allows a light beam to exit principally in the normal direction of the outgoing surface S1. Specifically, a light beam having entered the light guide plate 30 through the coupling structure 32 is partially reflected by the prism reflection array 35 so as to go out, as virtual-image reflection light R, to the exterior through the outgoing surface S1 of the light guide plate 30. Note that, in FIG. 2, the horizontal angle of view (±θ₀) of a virtual image is illustrated along with the virtual-image reflection light R.

The plurality of supporting prisms 35C are disposed in the surroundings of the prism reflection array 35. The supporting prisms 35C are not coated with any semi-reflective film 35r, hence not having optical effects on a light beam. Optically speaking, the “optical prisms 35A” and the “supporting prisms 35C” are clearly distinguishable members.

In the present embodiment, similar to the optical prisms 35A, the supporting prisms 35C are triangular prisms extending along the Y direction in a plane which is parallel to the outgoing surface S1. Therefore, the cross-sectional shape of a supporting prism 35C, as taken parallel to the XZ plane, also turns out triangular as illustrated in FIG. 3.

In the present specification, heights h of an optical prism 35A and a supporting prism 35C each denote, as illustrated in FIG. 3, a distance from the bottom face to the apex along the Z direction. The heights h are heights along the normal direction of the outgoing surface S1.

The prism reflection array 35 and the plurality of supporting prisms 35C are covered with the second light-guiding layer 33B. One face of the second light-guiding layer 33B has a shape which matches the shapes of the optical prisms 35A and the supporting prisms 35C formed in the first light-guiding layer 33A; the opposite surface defines the upper principal face S2 of the light guide plate 30. The second light-guiding layer 33B is a member for planarizing the surfaces of the prism reflection array 35 and the plurality of supporting prisms 35C, disposed so as to bury their rugged features. A surface of the planarized light guide plate 30 is supported by the apices (the portions corresponding to ridges 35L) of the supporting prisms 35C. The height of the supporting prisms 35C is greater than that of an optical prism 35A, so that the apices of the optical prisms 35A are not in contact with the surface of the light guide plate 30 but buried below.

In the present embodiment, the prism reflection array 35 is provided on the upper principal face S2 side of the light guide plate 30. However, the prism reflection array 35 may alternatively be provided on the lower principal face (i.e. the outgoing surface) S1 side of the light guide plate 30. In that case, the prism reflection array 35 is formed in the first light-guiding layer 33A so that a light beam exits principally in the normal direction of the outgoing surface S1, and further covered with the second light-guiding layer 33B; meanwhile, the outer surface of the second light-guiding layer 33B constitutes the lower (viewer's side) principal face S1 of the light guide plate 30.

As illustrated in FIG. 3, an optical prism 35A includes a first slope surface 35D and a second slope surface 35E. The first and second slope surfaces 35D and 35E form a ridge 35L (i.e., an apex). Of the first and second slope surfaces 35D and 35E, the second slope surface 35E is located on the light receiving portion 31 (see FIG. 1A) side of the light guide plate 30. The first slope surface 35D is inclined at a slope angle α with respect to the outgoing surface S1 of the light guide plate 30, whereas the second slope surface 35E is inclined with respect to the outgoing surface S1 at a slope angle β greater than the slope angle α. With the XY plane taken as reference, the slope angle α is an angle measured with the clockwise direction defined as positive; the slope angle β is an angle measured with the counterclockwise direction defined as positive. For example, the slope angle α is 26° while the slope angle β is 85°.

The first slope surface 35D is coated with a semi-reflective film 35r, which partially reflects a light beam (the propagating light L2 as illustrated in FIG. 2) propagating through the interior of the light-guiding layer 33 and partially transmits the light beam. The second slope surface 35E is not coated with any semi-reflective film 35. Moreover, in the prism reflection array 35, at positions near the light receiving portion 31, a parallel surface 35B is provided between each two adjacent optical prisms 35A. Those parallel surfaces 35B also are coated with semi-reflective films 35r. On the other hand, at positions far from the light receiving portion 31, there is no parallel surface 35B provided between two adjacent optical prisms 35A, but the optical prisms 35A are closely and contiguously arranged.

By selectively coating the first slope surfaces 35D and the parallel surfaces 35B alone with the semi-reflective films 35r, it is possible to cause the propagating light L2 propagating through the interior of the light guide plate 30 to be partially reflected off the first slope surfaces 35D and off the parallel surfaces 35B, while allowing incident light from outside the upper principal face S2 of the light guide plate 30 (i.e., light from the exterior) to exit through the lower principal face S1 of the light guide plate 30.

The propagating light L2 in the light guide plate is reflected at the first slope surfaces 35D and the parallel surfaces 35B of the optical prisms 35A, but not reflected at the second slope surfaces 35E. The reason why the second slope surfaces 35E alone are left uncoated is that, if the second slope surfaces 35E constituted semi-reflective surfaces, the light would be reflected in unexpected directions to become stray light, thus making it more difficult to perform high-quality virtual image displaying.

FIG. 4 schematically illustrates a cross section as taken parallel to the XZ plane, principally illustrating the internal structure of the first light-guiding layer 33A. Given the aforementioned size example of the light guide plate 30, along the X direction, let an end position at the side having the light receiving portion 31 of the light guide plate 30 be X=0 mm, and then the end position at the opposite side from the light receiving portion 31 of the light guide plate 30 will be X=55 mm.

The first light-guiding layer 33A has the prism reflection array 35 and the plurality of supporting prisms 35C. For example, the prism reflection array 35 may be positioned so as to span from X=20 mm to 45 mm along the X direction, while the plurality of supporting prisms 35C may be positioned so as to span from X=0 mm to 20 mm and from X=45 mm to 55 mm along the X direction. The supporting prisms 35C have a height hs of 0.18 mm, for example; meanwhile, the optical prisms 35A have heights ho of 0.14 mm, for example. On the other hand, in the surroundings of the prism reflection array 35, there is no parallel surface 35B between two adjacent supporting prisms 35C. The pitch ps of two adjacent supporting prisms 35C is 3.0 mm, for example. The array pitch of the optical prisms 35A will be described later.

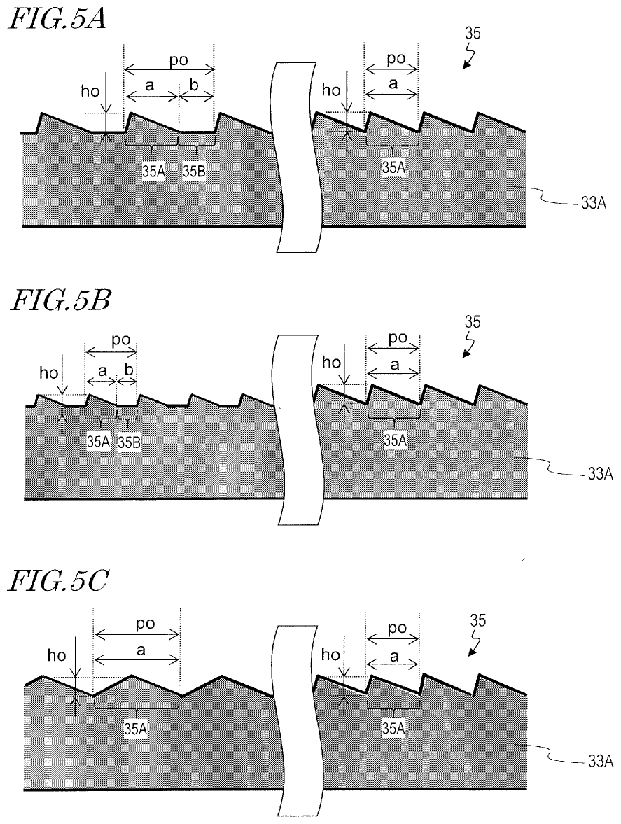

FIG. 5A to FIG. 5C schematically illustrate exemplary array patterns of the plurality of optical prisms 35A in a closer region and a farther region relative to the coupling structure 32. The left-hand side in the drawing is the side of the light guide plate 30 at which the light receiving portion 31 is located.

First, the reason why the array patterns of the optical prisms 35A are varied according to their positions in the prism reflection array 35 is explained. When a light beam having reflected off the prism reflection array 35 exits from the light guide plate 30, the outgoing surface S1 may in some cases be observed to vary in brightness from position to position. One presumable cause thereof is that a uniform in-plane distribution of the reflecting surfaces in the prism reflection array 35 of the light guide plate 30 will lead to a relatively higher intensity of the collimated light exiting on the side that is closer to the light receiving portion 31 (on which the light from the display element 10 is incident) and a relatively lower intensity of the collimated light exiting on the farther side.

In order that the virtual-image reflection light R be uniformly extracted within a region where the prism reflection array 35 is disposed, the optical prisms 35A are preferably arranged so that the occupancy of the first slope surfaces 35D per unit area starts smaller at positions near the light receiving portion 31 and increases away from the light receiving portion 31. Accordingly, there may be parallel surfaces 35B between two adjacent optical prisms 35A at positions near the light receiving portion 31; the number of those parallel surfaces 35B therebetween may decrease away from the light receiving portion 31 gradually or stepwise, so that there are no parallel surfaces 35B at the farthest positions from the light receiving portion 31.

As shown in FIG. 5A to FIG. 5C, let po be the array pitch of the optical prisms 35A, let a be the width of an optical prism 35A, and let b be the width of a parallel surface 35B. Note that the array pitch po corresponds to the distance between the apices of two adjacent optical prisms 35A.

In the example illustrated in FIG. 5A, the width a is kept constant irrespective of the position of the optical prism 35A, whereas the width b is allowed to decrease away from the light receiving portion 31. As a result, the array pitch p also gradually decreases away from the light receiving portion 31. For example, the width a may be 0.30 mm, whereas the width b may be chosen so that the array pitch po gradually decreases from 0.54 mm to 0.30 mm.

In the example illustrated in FIG. 5B, the array pitch po is kept constant irrespective of the position of the optical prism 35A, whereas the width a is allowed to gradually increase away from the light receiving portion 31. As a result, the width b gradually decreases away from the light receiving portion 31; meanwhile, the height ho of an optical prism 35A increases away from the light receiving portion 31. For example, the height ho is 0.14 mm at the most.

In the example illustrated in FIG. 5C, instead of disposing a parallel surface 35B between two adjacent optical prisms 35A, the shape of an optical prism 35A is varied according to the position of the optical prism 35A. Specifically, the slope angle α of the first slope surface 35D in an optical prism 35A is kept constant, whereas the slope angle β of the second slope surface 35E is chosen so as to increase away from the light receiving portion 31. In this example, the array pitch po is equal to the width a of an optical prism 35A. However, with formation (oblique vapor deposition as will be described later) of the semi-reflective films 35r taken into account, the slope angle β may preferably be as large as possible insofar as less than 90°. Furthermore, in order to project the virtual-image reflection light R (see FIG. 2) onto a viewer's pupil by way of the prism reflection array 35, the array pitch po is preferably less than the pupil diameter. A pupil diameter varies from about 2.0 mm to 8.0 mm depending on the environment. With this further taken into account, more preferably, the array pitch po may be less than the minimum pupil diameter of 2 mm.

So long as the height hs of a supporting prism 35C is greater than the height ho of an optical prism 35A, their shapes do not need to be geometrically similar, but rather the shape of the supporting prism 35C may be a dissimilar prism shape or a lens shape. Moreover, the supporting prisms 35C do not need to each linearly extend but may be arranged in a dot pattern. In that case, the supporting prisms 35C may be dome-shaped, for example. Instead of arranging the plurality of supporting prisms 35C, a single supporting body may be disposed as a structure in the surroundings of the prism reflection array 35. Furthermore, the supporting prisms 35C do not necessarily need to be provided in the light-guiding layer 30 via molding, but may alternatively be spacers which define the thickness of the light-guiding layer along the normal direction of the outgoing surface S1. The spacers may be provided in the light-guiding layer 30 by spraying. The material of the spacers is a glass, for example.

In the present embodiment, with variations in brightness taken into account, the prism reflection array 35 having the parallel surfaces 35B, for example, is employed so that the surface density (occupancy per unit area) of the optical prisms 35A increases away from the light receiving portion 31. However, such a construction is not necessarily required.

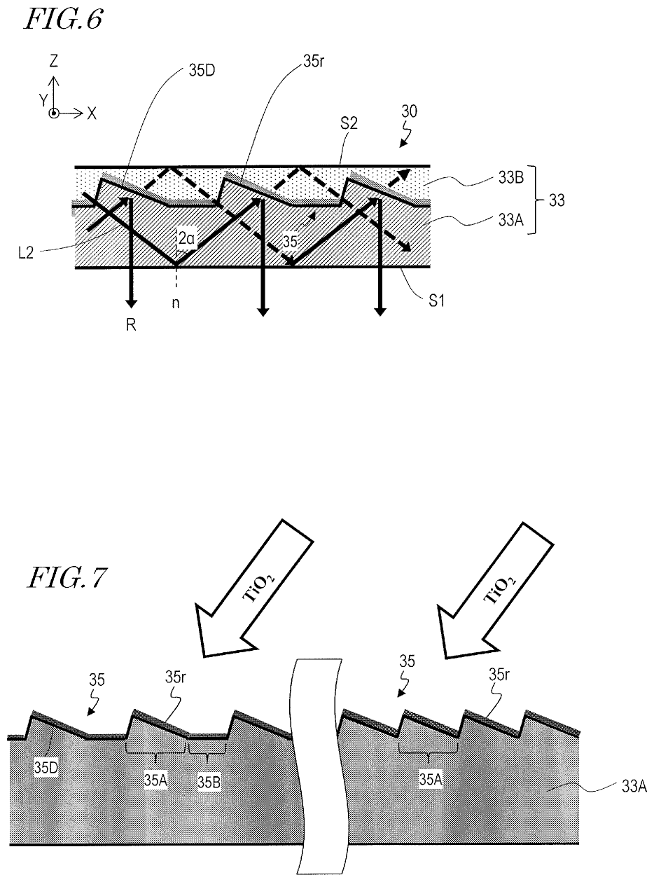

With reference to FIG. 6, and with special attention on virtual-image projection light from the center of the display element 10 of the virtual image projection device 40, behavior of the propagating light L2 in the light guide plate 30 will be described. The virtual-image reflection light R is collimated light, which forms a virtual image that is viewable in the substantial front of a viewer.

FIG. 6 schematically illustrates a cross section of the light guide plate 30 in the XZ plane.

A light beam incident through the light receiving portion 31 (see FIG. 4), which is located at an end of the light guide plate 30, propagates through the interior while undergoing total reflections at the upper and lower principal faces S1 and S2 of the light guide plate 30. Specifically, a light beam undergoes total reflections at the interfaces, so long as it is incident on the upper and lower principal faces S1 and S2 of the light guide plate 30 at an incident angle not less than a critical angle as determined by the relative refractive index of the light guide plate 30 with respect to the external medium (which herein is air). Then, while repeating total reflections, the incident light beam propagates through the interior of the light guide plate 30 principally along the X direction shown in FIG. 6.

The propagating light L2 is reflected off the first slope surface 35D (i.e., semi-reflective film 35r) of an optical prism 35A. The reflected light typically exits in the normal direction n of the outgoing surface S1 of the light guide plate 30. The outgoing light beam will reach the viewer's pupil. On the other hand, a light beam having been transmitted through the semi-reflective film 35r propagates through the interior of the light guide plate 30 again, so as to reach another optical prism 35A.

In a scenario where the propagating light L2 exits in the normal direction n of the outgoing surface S1, the propagating light L2 is incident at an incident angle α (which is equal to the slope angle α of the first slope surface 35D) with respect to the first slope surface 35D of the optical prism 35A. Moreover, the light to be incident at this incident angle α is light which travels through the light guide plate 30 in a direction that is different from the normal direction n by an angle of 2α: i.e., light which may undergo total reflection off the lower face of the light guide plate 30, as illustrated in the drawing. In this respect, as a condition for the light to repeat total reflections through the interior of the light guide plate 30, reach a first slope surface 35D, and be reflected so as to exit along the normal direction n, θ_{c}≤2α<90° needs to be satisfied, where e denotes a critical angle of the light guide plate 30, and where light undergoes total reflection so long as it is incident on the upper and lower faces of the light guide plate 30 at an incident angle not less than the critical angle θ₀. Hence, preferably, the slope angle α of an optical prism 35A is chosen such that θ_{c}/2≤α<45° is satisfied.

Next, a method of producing a virtual image display apparatus 100 will be described.

As illustrated in FIG. 1A, a virtual image display apparatus 100 includes a display element 10, a projection lens system 20, a light guide plate 30, and a coupling structure 32, and is produced by appropriately disposing these. As mentioned earlier, the display element 10 and the projection lens system 20 can be of various implementations. On the other hand, the display element 10, the projection lens system 20, and the light guide plate 30 may be appropriately disposed for the application through known methods, which will not be described in detail here. In the present specification, a method of producing a lightguide which has a light guide plate 30 including a prism reflection array 35 and which has a coupling structure 32 will mainly be described.

A light guide plate 30 is obtained by molding a prism reflection array 35 in a first transparent material (e.g. UV-curable resin), molding a plurality of supporting prisms 35C in its surroundings, forming semi-reflective films 35r on certain slope surfaces of the prism reflection array 35, and then planarizing the prism reflection array 35 with a second transparent material (e.g. UV-curable resin). Specifically, the prism reflection array 35 and the plurality of supporting prisms 35C may be produced by molding with the first transparent material (e.g., a thermoplastic resin, a UV-curable resin, etc.) using injection molding, compression molding, and the 2p process (Photo Polymerization Process), for example. The semi-reflective films 35r are formed by vapor-depositing metal films, dielectric films, or the like to predetermined film thicknesses on first slope surfaces 35D of molded optical prisms 35A, for example. As will be described later, during the vapor deposition, a mask is used so that the semi-reflective films 35r are not vapor-deposited on the supporting prisms 35C. Thereafter, as a planarization member, the second transparent material such as a photocurable (typically, ultraviolet-curable) resin, a thermosetting resin, a two-component epoxy resin, or the like is applied over the prism reflection array 35 and the plurality of supporting prisms 35C, and further pressurized-filled, whereupon the second transparent material (i.e., resin) is cured by polymerization. Through the above steps, a light guide plate 30 which has a light-guiding layer 33 including the prism reflection array 35 is completed. Preferably, the refractive index of the first transparent material is identical to that of the second transparent material.

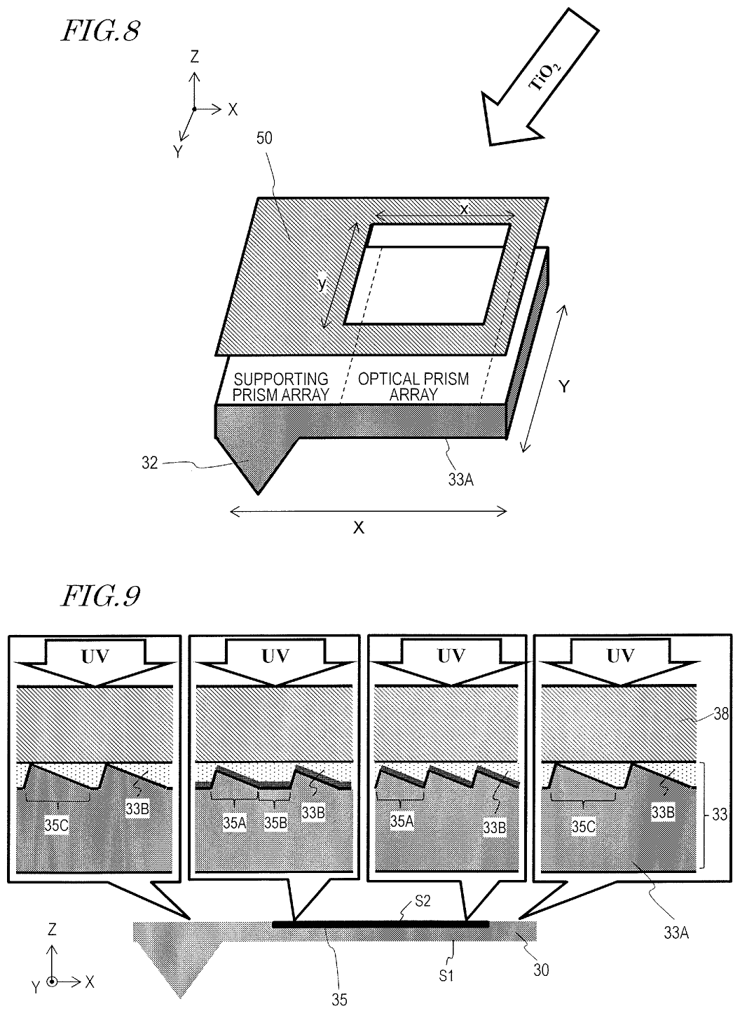

With reference to FIG. 7 to FIG. 9, a method of producing a light guide plate 30 will be described in detail.

FIG. 7 schematically illustrates how semi-reflective films 35r may be formed on the prism reflection array 35 through oblique vapor deposition. FIG. 8 schematically illustrates a mask 50 which is used so that the semi-reflective films 35r are vapor-deposited exclusively onto predetermined surfaces of the optical prisms 35A. FIG. 9 schematically illustrates how, after a second transparent material which has been applied over the prism reflection array 35 is pressed under a quartz substrate 38 for pressurized filling, the second transparent material may be cured by polymerization through UV (Ultraviolet) irradiation.

As the first transparent material for a first light-guiding layer 33A, “ZEONEX 330R” (refractive index=1.51) manufactured by ZEON CORPORATION may be used, for example. In the first transparent material, a prism reflection array 35 and a plurality of supporting prisms 35C are molded through injection molding. This molding gives a transparent member in which the prism reflection array 35 and the plurality of supporting prisms 35C are formed as an integral piece, as illustrated in FIG. 4. Injection molding is a molding method in which a molding resin heated to become fluid is injected into a die under a high pressure so that the shape of the die will be transferred thereto.

As illustrated in FIG. 7, by vapor-depositing TiO₂ to a film thickness (of about 65 nm) on the plurality of first slope surfaces 35D and the plurality of parallel surfaces 35B in the prism reflection array 35, semi-reflective films 35r are formed. In doing so, a mask 50 as illustrated in FIG. 8 is used so that the semi-reflective films 35r are formed exclusively in an x (25 mm)×y (20 mm) region, which corresponds to a region in which the optical prisms 35A have been arrayed. Note that other dielectric or metal materials (e.g., Al or Ag) may be used as the material for the semi-reflective films 35r instead of TiO₂. Furthermore, preferably, oblique vapor deposition is employed so that the semi-reflective films 35 are not formed on the second slope surfaces 35E of the optical prisms 35A. This is because forming any semi-reflective films 35r on the second slope surfaces 35E would cause the propagating light L2 inside the light guide plate 30 to be reflected in directions which are different from predetermined directions, thus resulting in blurring and ghosting of the virtual image.

As the second transparent material for a second light-guiding layer 33B, which is a planarization member, a UV-curable resin “LU1303HA” (refractive index=1.51) manufactured by DAICEL may be used, for example. After the second transparent material is applied over the prism reflection array 35 and the plurality of supporting prisms 35C, and further pressed under a quartz substrate 38 for pressurized filling, the second transparent material is cured by polymerization using UV irradiation through the quartz substrate 38.

Pressing under the quartz substrate 38 provides for planarity of the surface of the light guide plate 30, and also provides flatness between the lower principal face (i.e., outgoing surface) S1 and the upper principal face S2 of the light guide plate 30, because the quartz substrate 38 is supported by the supporting prisms 35C. Furthermore, since the height of the supporting prisms 35C is greater than that of an optical prism 35A, the quartz substrate 38 does not contact any apices of the optical prisms 35A. As a result, deformation or destruction of the semi-reflective films 35r associated with deformation of the apices of the optical prisms 35A can be avoided. On the other hand, even if any apices of the supporting prisms 35C are deformed, their optical influences will be very trivial, since there is no semi-reflective film 35r formed thereon. Note that a release treatment, e.g. by using a release agent, may preferably be applied to the quartz substrate 38 so as to enable easy removal after the second transparent material is cured.

According to the light guide plate 30 of the present embodiment, scattering of the propagating light L2 inside the light guide plate 30 can be reduced. As a result, a high-quality virtual image may be projected onto a viewer's pupil.

### Second Embodiment

A light guide plate 30A according to the present embodiment differs from the light guide plate 30 according to the first embodiment in that the array direction of a plurality of supporting prisms 35C is orthogonal to that of a plurality of optical prisms 35 in the prism reflection array 35. Hereinafter, differences from the light guide plate 30 according to the first embodiment will mainly be described.

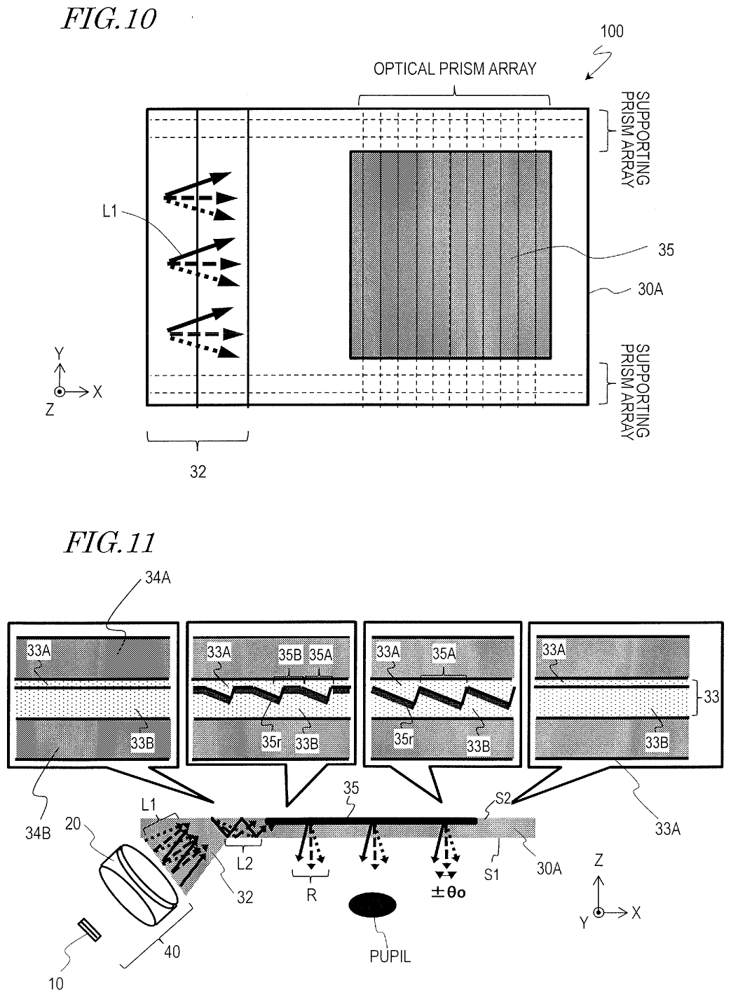

FIG. 10 is a plan view of a virtual image display apparatus 100 according to the present embodiment. FIG. 11 schematically illustrates a cross section as taken parallel to the XZ plane, mainly illustrating the internal structure of a light guide plate 30A. FIG. 12 schematically illustrates a side face of the light guide plate 30A as viewed along the X direction.

As illustrated in FIG. 10, similarly to the first embodiment, an optical prism 35A is a triangular prism extending along the Y direction in a plane which is parallel to the outgoing surface S1. The prism reflection array 35 has a plurality of optical prisms 35A being arranged along the X direction, which is orthogonal to the Y direction. Along the Y direction, a plurality of supporting prisms 35C are arranged within regions (supporting prism array regions) in the surroundings of the prism reflection array 35, these regions sandwiching, along the Y direction, a region (optical prism array region) where the prism reflection array 35 is disposed. In other words, each optical prism 35A extends along the Y direction, which is orthogonal to the X direction, whereas each supporting prism 35C extends along the X direction. Each supporting prism 35C according to the present embodiment, which is arc-shaped in a cross section taken parallel to the YZ plane, extends along the X direction in a plane which is parallel to the outgoing surface S1.

A light guide plate 30A according to the present embodiment further includes first and second transparent substrates 34A and 34B which sandwich the light-guiding layer 33. The first transparent substrate 34A supports the first light-guiding layer 33A, whereas the second transparent substrate 34B supports the second light-guiding layer 33B. One advantage is that sandwiching the light-guiding layer 33 between the transparent substrates allows the strength and durability of the light guide plate 30 to be enhanced. Another advantage is that using the transparent substrates makes it easy to produce the light guide plate 30. The plurality of supporting prisms 35C are formed in the first light-guiding layer 33A together with the prism reflection array 35. On the other hand, the height of the supporting prisms 35C is greater than that of an optical prism 35A.

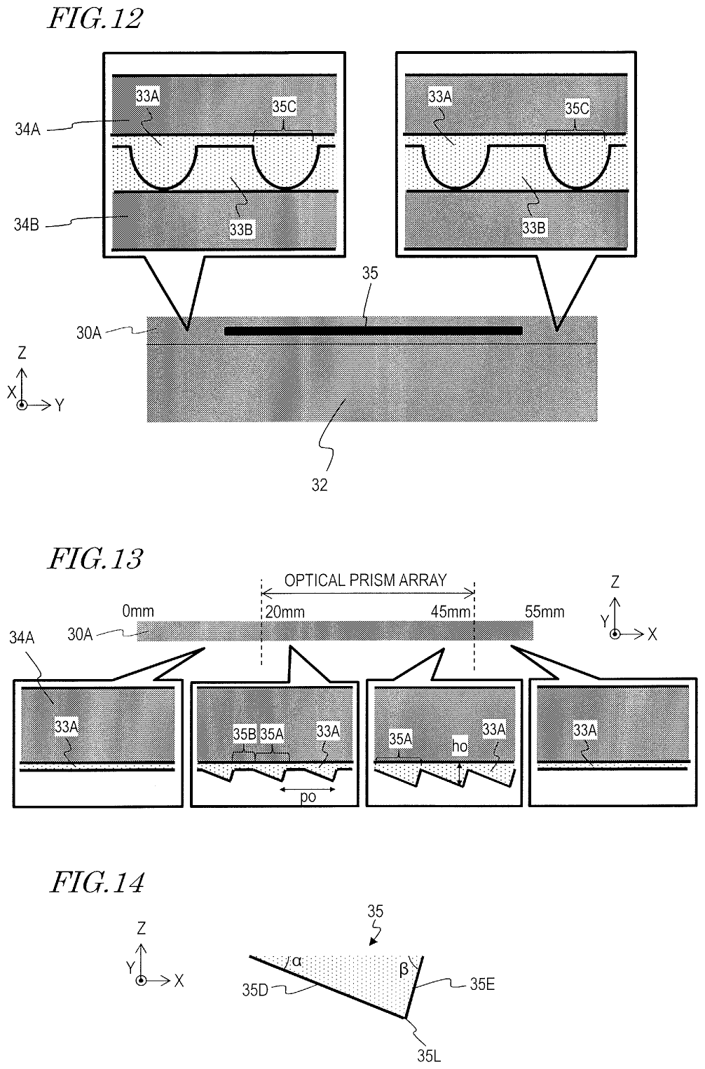

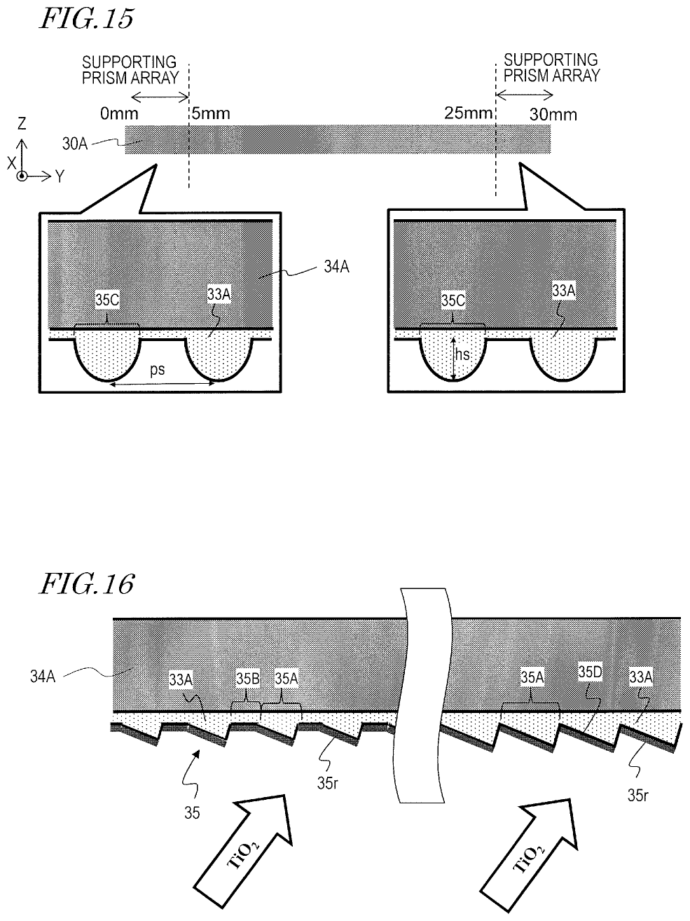

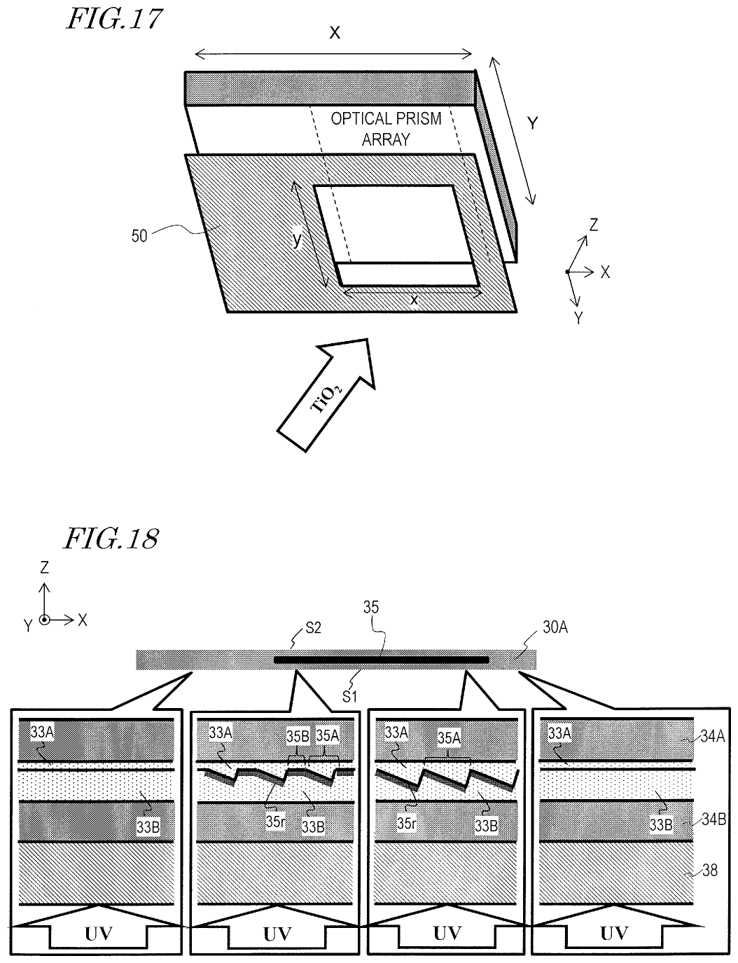

FIG. 13 schematically illustrates a cross section as taken parallel to the XZ plane, illustrating the internal structure of the first light-guiding layer 33A which is supported by the first transparent substrate 34A. FIG. 14 schematically illustrates an enlarged cross section of one of the plurality of optical prisms 35A in the prism reflection array 35, as taken parallel to the XZ plane. FIG. 15 schematically illustrates a cross section of the light guide plate 30A, as taken parallel to the YZ plane.

As illustrated in the figures, the first light-guiding layer 33A is supported by the first transparent substrate 34A. The prism reflection array 35 has the same structure as in the first embodiment. Given the size example of the light guide plate 30 as described in the first embodiment, along the X direction, let an end position at the side having the light receiving portion 31 of the light guide plate 30 be X=0 mm, and then the end position at the opposite side from the light receiving portion 31 of the light guide plate 30 will be X=55 mm. Along the Y direction, let an end position of the light guide plate 30 be Y=0 mm, and the other end position will be Y=30 mm.

For example, as in the first embodiment, the prism reflection array 35 is positioned so as to span from X=20 mm to 45 mm along the X direction. The height ho of an optical prism 35A is 0.14 mm at the most, for example. The pitch po between two adjacent optical prisms 35A is 0.3 mm, for example.

For example, the plurality of supporting prisms 35C are positioned so as to span from Y=0 mm to 5 mm and from Y=25 mm to 30 mm along the Y direction. Note that the prism reflection array 35 may be positioned so as to span from Y=5 mm to 25 mm. The height hs of the supporting prisms 35C is 0.18 mm, for example. The pitch ps between two adjacent supporting prisms 35C is 3.0 mm, for example.

Next, with reference to FIG. 16 to FIG. 19, a method of producing a light guide plate 30A will be described.

FIG. 16 schematically illustrates how semi-reflective films 35r may be formed on the prism reflection array 35 through oblique vapor deposition. FIG. 17 schematically illustrates a mask 50 which is used so that the semi-reflective films 35r are vapor-deposited exclusively onto predetermined surfaces of the optical prisms 35A. FIG. 18 schematically illustrates how, after a second transparent material which has been applied over the prism reflection array 35 is pressed with a quartz substrate 38 for pressurized filling, the resin may be cured by polymerization through UV irradiation. FIG. 19 schematically illustrates how, after a second transparent material which has been applied over the plurality of supporting prisms 35C is pressed with a quartz substrate 38 for pressurized filling, the resin may be cured by polymerization through UV irradiation.

First, a first transparent substrate 34A is provided. As the first transparent substrate 34A, a glass substrate “EagleXG” (refractive index=1.51) manufactured by CORNING INCORPORATED may be used, for example. The thickness of the first transparent substrate 34A is 1.1 mm, for example. As the first transparent material for a first light-guiding layer 33A, a UV-curable resin “LU1303HA” (refractive index=1.51) manufactured by DAICEL CORPORATION may be used, for example. A prism reflection array 35 is molded in the first transparent material on the first transparent substrate 34A by the 2p process. In the 2p process, the UV-curable resin is applied over a die, upon which the first transparent substrate 34A is further disposed; thereafter, the UV-curable resin is pressurized-filled, cured by polymerization, and then released from the die. Thus, a transparent member is obtained which has a shape of the die transferred thereon and which is supported by the first transparent substrate 34A.

As illustrated in FIG. 16, similarly to the first embodiment, by vapor-depositing TiO₂ to a film thickness (of about 65 nm) on the plurality of first slope surfaces 35D and the plurality of parallel surfaces 35B in the prism reflection array 35, semi-reflective films 35r are formed. In doing so, a mask 50 as illustrated in FIG. 17 is used so that the semi-reflective films 35r are formed exclusively in an x (25 mm)×y (20 mm) region, which corresponds to a region in which the optical prisms 35A have been arrayed. Furthermore, preferably, oblique vapor deposition is employed so that the semi-reflective films 35 are not formed on the second slope surfaces 35E of the optical prisms 35A.

As the second transparent material for a second light-guiding layer 33B, which is a planarization member, a UV-curable resin “LU1303HA” (refractive index=1.51) manufactured by DAICEL may be used, for example. On the other hand, as a second transparent substrate 34B, a glass substrate “EagleXG” (refractive index=1.51, thickness=1.1 mm) manufactured by CORNING INCORPORATED may be used, which is the same as the first transparent substrate 34A. The second transparent material is applied over the prism reflection array 35 and the plurality of supporting prisms 35C; thereover, the second transparent substrate 34B is further disposed and pressed with a quartz substrate 38 so that the second transparent material is pressurized-filled;

thereafter, the second transparent material is cured by polymerization using UV irradiation through the quartz substrate 38. Note that the coupling structure 32 may be provided as a separate member from the light guide plate 30, and then adhesively bonded to the second transparent substrate 34B of the light guide plate 30.

Since the lower and upper principal faces S1 and S2 of the light guide plate 30A are defined respectively by the surfaces of the first and second transparent substrates 34A and 34B, planarity of each principal face is provided. Also, by being pressed with the quartz substrate 38, the second transparent substrate 34B becomes supported by the supporting prisms 35C, whereby flatness between the lower principal face S1 and the upper principal face S2 of the light guide plate 30A is provided. Furthermore, because the height of the supporting prisms 35C is greater than that of an optical prism 35A, the second transparent substrate 34B does not contact any apices of the optical prisms 35A; as a result, deformation or destruction of the semi-reflective films 35r associated with deformation of the apices of the optical prisms 35A can be avoided. On the other hand, even if any apices of the supporting prisms 35C are deformed, their optical influences will be very trivial, because the supporting prisms 35C do not have any semi-reflective films 35r and also because they are disposed off the optical paths through which the propagating light L2 reaches the prism reflection array.

According to the light guide plate 30A of the present embodiment, scattering of the propagating light L2 inside the light guide plate 30A can be reduced. As a result, a high-quality virtual image may be projected onto a viewer's pupil.

### Third Embodiment

A light guide plate 30B according to the present embodiment differs from the light guide plate 30 according to the first embodiment, firstly in that the light-guiding layer 33 further includes a third light-guiding layer 33C having a plurality of supporting prisms 35C, and secondly in that the array direction of the plurality of supporting prisms 35C is orthogonal to that of a plurality of optical prisms 35 in the prism reflection array 35. However, as for the first aspect, the light guide plate 30B according to the present embodiment is common to the light guide plate 30A according to the second embodiment. Hereinafter, differences from the light guide plates 30 and 30A according to the first and second embodiments will mainly be described.

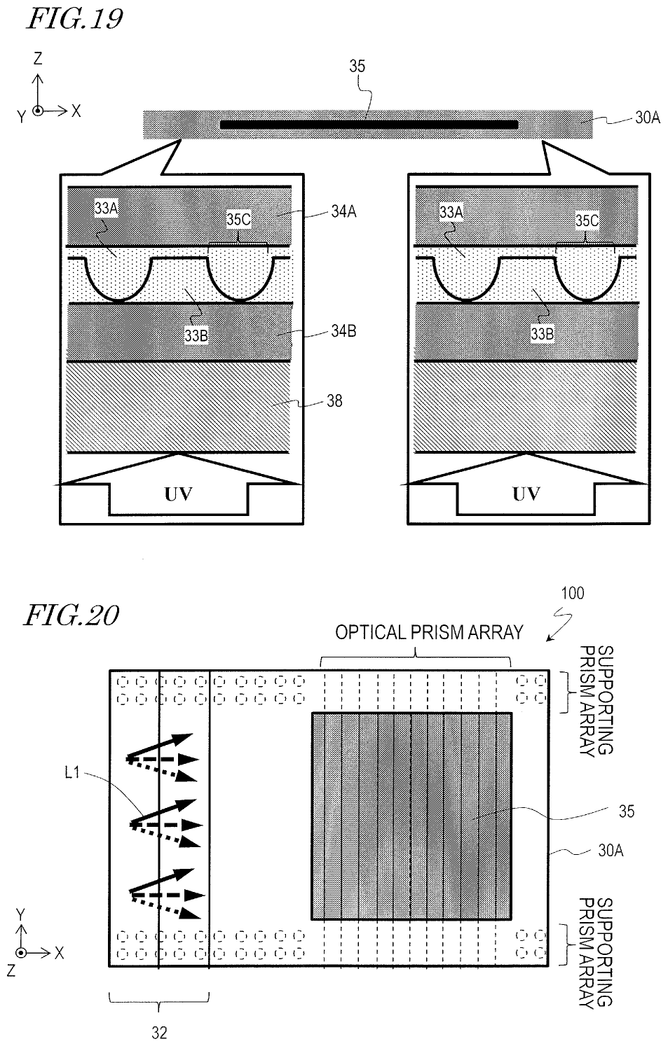

FIG. 20 is a plan view of a virtual image display apparatus 100 according to the present embodiment. As illustrated in FIG. 20, similarly to the first embodiment, an optical prism 35A is a triangular prism extending along the Y direction in a plane which is parallel to the outgoing surface S1. The prism reflection array 35 has a plurality of optical prisms 35A being arranged along the X direction, which is orthogonal to the Y direction. A plurality of supporting prisms 35C are arranged in a dot pattern within regions (supporting prism array regions) in the surroundings of the prism reflection array 35, these regions sandwiching, along the Y direction, a region (optical prism array region) where the prism reflection array 35 is disposed. The supporting prisms 35C according to the present embodiment, each arc-shaped in cross sections as taken parallel to the XZ plane and the YZ plane, are arranged in a dot pattern in a plane which is parallel to the outgoing surface S1.

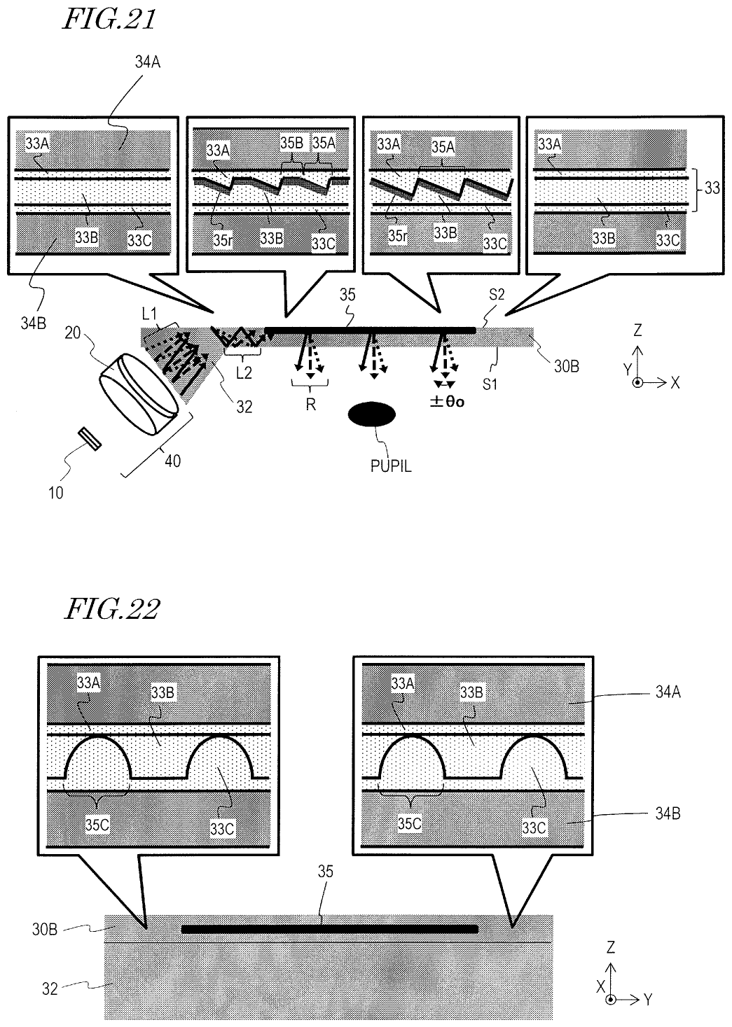

FIG. 21 schematically illustrates a cross section as taken parallel to the XZ plane, mainly illustrating the internal structure of a light guide plate 30B. FIG. 22 schematically illustrates a side face of the light guide plate 30B as viewed along the X direction.

A light guide plate 30B according to the present embodiment further includes first and second transparent substrates 34A and 34B which sandwich the light-guiding layer 33, the light-guiding layer 33 further having a third light-guiding layer 33C. In other words, the light-guiding layer 33 has the first, second, and third light-guiding layers 33A, 33B, and 33C. The prism reflection array 35 is formed in the first light-guiding layer 33A, whereas the plurality of supporting prisms 35C are formed in the third light-guiding layer 33C. The apices of the supporting prisms 35C are in contact with a surface of the first light-guiding layer 33A, the surface being on the opposite side from the first transparent substrate 34A. As in the first and second embodiments, the height of the supporting prisms 35C is greater than that of an optical prism 35A.

See FIG. 13 again. As in the second embodiment, the first light-guiding layer 33A is supported by the first transparent substrate 34A, while the prism reflection array 35 is positioned so as to span from X=20 mm to 45 mm along the X direction, for example. The height ho of an optical prism 35A is 0.14 mm at the most, for example. The pitch po between two adjacent optical prisms 35A is 0.3 mm, for example.

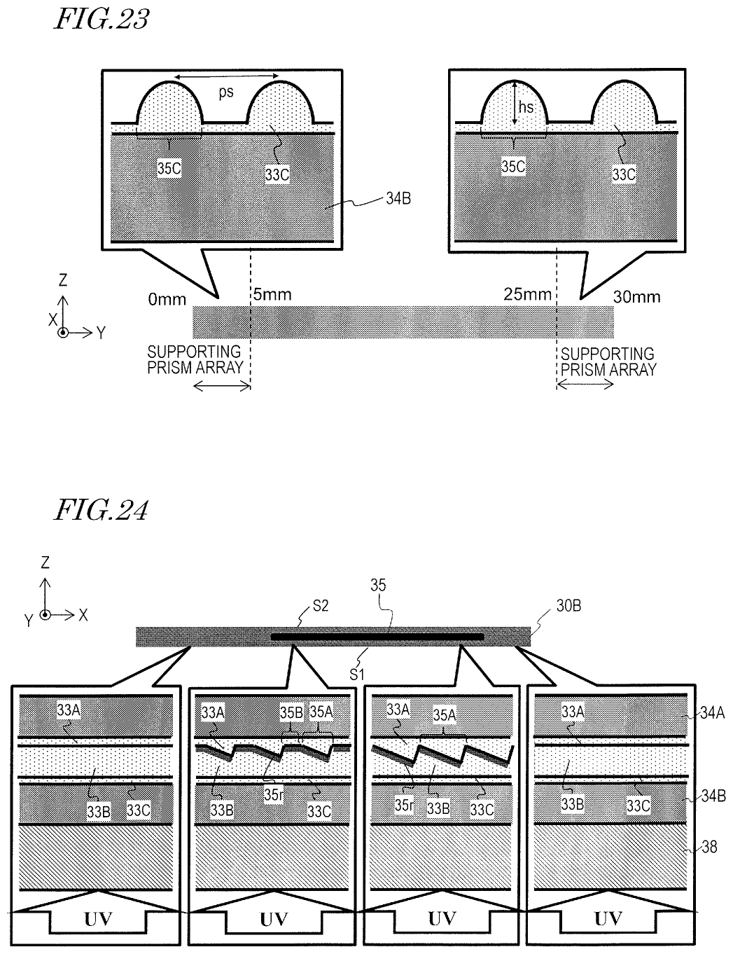

FIG. 23 schematically illustrates a cross section of the light guide plate 30B as taken parallel to the YZ plane. Given the size example of the light guide plate 30 as described in the first embodiment, along the Y direction, let an end position of the light guide plate 30B be Y=0 mm, and the other end position will be Y=30 mm.

The plurality of supporting prisms 35C are positioned so as to span from Y=0 mm to 5 mm and from Y=25 mm to 30 mm along the Y direction, and simultaneously, from X=0 mm to 20 mm and from X=45 mm to 55 m along the X direction, for example. Note that the prism reflection array 35 may span from Y=5 mm to 25 mm. The height hs of the supporting prisms 35C is 0.18 mm, for example. The pitch ps between two adjacent supporting prisms 35C is 3.0 mm, for example. Each supporting prism 35C is arc-shaped in cross sections as taken parallel to the XZ plane and the YZ plane.

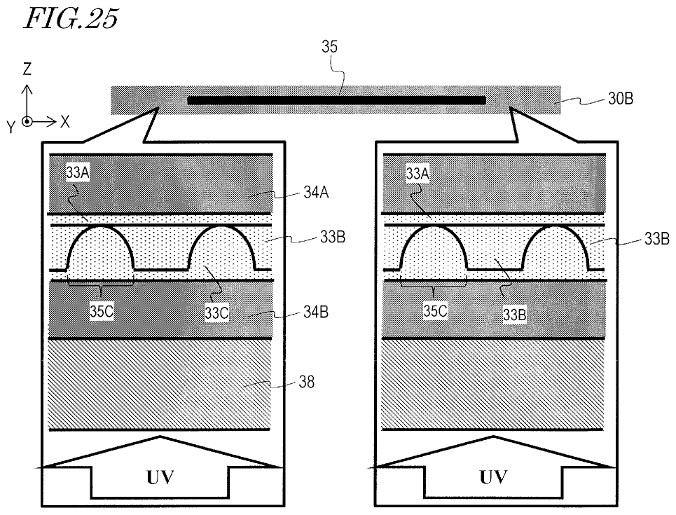

Next, with reference to FIG. 24 and FIG. 25, a method of producing a light guide plate 30B will be described.

FIG. 24 schematically illustrates how, after a second transparent material which has been applied over the prism reflection array 35 is pressed with a quartz substrate 38 for pressurized filling, the second transparent material may be cured by polymerization through UV irradiation. FIG. 25 schematically illustrates how, after a second transparent material which has been applied over the plurality of supporting prisms 35C is pressed with a quartz substrate 38 for pressurized filling, the second transparent material may be cured by polymerization through UV irradiation.

First, by a method similar to the method described in the second embodiment, a transparent member which is supported by a first transparent substrate 34A and which has a prism reflection array 35 molded therein is produced. As the first transparent substrate 34A, a glass substrate “EagleXG” (refractive index=1.51) manufactured by CORNING INCORPORATED may be used, for example. The thickness of the first transparent substrate 34A is 1.1 mm, for example. As the first transparent material for a first light-guiding layer 33A, a UV-curable resin “LU1303HA” (refractive index=1.51) manufactured by DAICEL CORPORATION may be used, for example.

Furthermore, as in the second embodiment, by vapor-depositing TiO₂ to a film thickness (of about 65 nm) on the plurality of first slope surfaces 35D and the plurality of parallel surfaces 35B in the prism reflection array 35, semi-reflective films 35r are formed. In doing so, a mask 50 is used so that the semi-reflective films 35r are formed exclusively in an x (25 mm)×y (20 mm) region, which corresponds to a region in which the optical prisms 35A have been arrayed. At this time, preferably, oblique vapor deposition is employed so that the semi-reflective films 35 are not formed on the second slope surfaces 35E of the optical prisms 35A.

Next, a second transparent substrate 34B is provided. As the second transparent substrate 34B, e.g. a glass substrate “EagleXG” (refractive index=1.51) manufactured by CORNING INCORPORATED may be used, which is the same as the first transparent substrate 34A. The thickness of the second transparent substrate 34B is 1.1 mm, for example. As the third transparent material for a third light-guiding layer 33C, a UV-curable resin “LU1303HA” (refractive index=1.51) manufactured by DAICEL CORPORATION may be used, for example. A plurality of supporting prisms 35C are molded in the third transparent material on the second transparent substrate 34B by the 2p process. Thus, a transparent member is obtained which has a shape of the die transferred thereon and which is supported by the second transparent substrate 34B. In the present embodiment, the plurality of supporting prisms 35C are produced as members which are independent from the prism reflection array 35.

Next, as the second transparent material for a second light-guiding layer 33B, which is a planarization member, a UV-curable resin “LU1303HA” (refractive index=1.51) manufactured by DAICEL may be used, for example. The second transparent material is applied over the entire transparent members so as to cover the prism reflection array 35. The transparent members on the first transparent substrate 34A and the second transparent substrate 34B are overlaid with each other. Thereupon, after being pressed with a quartz substrate 38 for pressurized filling, the second transparent material, which is a planarization member, is cured by polymerization using UV irradiation through the quartz substrate 38. Note that the coupling structure 32 may be provided as a separate member from the light guide plate 30, and then adhesively bonded to the second transparent substrate 34B of the light guide plate 30.

Since the lower and upper principal faces S1 and S2 of the light guide plate 30A are defined respectively by the surfaces of the first and second transparent substrates 34A and 34B, planarity of each principal face is provided. And also, by being pressed with the quartz substrate 38, the first transparent substrate 34A becomes supported by the supporting prisms 35C, whereby flatness between the lower principal face S1 and the upper principal face S2 of the light guide plate 30A is provided. Furthermore, because the height of the supporting prisms 35C is greater than that of an optical prism 35A, the second transparent substrate 34B does not contact any apices of the optical prisms 35A; as a result, deformation or destruction of the semi-reflective films 35r associated with deformation of the apices of the optical prisms 35A can be avoided. On the other hand, even if any apices of the supporting prisms 35C are deformed, their optical influences will be very trivial, because the supporting prisms 35C do not have any semi-reflective films 35r and also because they are disposed off the optical paths through which the propagating light L2 reaches the prism reflection array.

According to the light guide plate 30B of the present embodiment, scattering of the propagating light L2 inside the light guide plate 30B can be reduced. As a result, a high-quality virtual image may be projected onto a viewer's pupil.

The present specification discloses light guide plates, lightguides, and virtual image display apparatuses as described in the following Items.

### [Item 1]

A light guide plate comprising:

a light-guiding layer having a first light-guiding layer, the first light-guiding layer including a prism reflection array which is constructed so as to partially transmit a light beam propagating therein, and a second light-guiding layer covering the prism reflection array;

an outgoing surface via which the light beam transmitted through the prism reflection array is allowed to exit; and

at least one supporting body having, along a normal direction of the outgoing surface, a height which is greater than a height of the prism reflection array.

In accordance with the light guide plate of Item 1, there is provided a light guide plate which can reduce scattering of light inside the light guide plate and which can thus reduce blurring of virtual images to be projected onto a viewer's eye.

### [Item 2]

The light guide plate of Item 1, wherein the at least one supporting body is disposed in surroundings of the prism reflection array.

With the light guide plate of Item 2, optical effects of the at least one supporting body on propagating light can be reduced.

### [Item 3]

The light guide plate of Item 1 or 2, wherein the prism reflection array has a plurality of prisms arranged along a first direction in a plane which is parallel to the outgoing surface, each prism extending along a second direction which is orthogonal to the first direction, the at least one supporting body extending along the second direction.

In accordance with the light guide plate of Item 3, there is provided a variation of the light guide plate.

### [Item 4]

The light guide plate of Item 1 or 2, wherein the prism reflection array has a plurality of prisms arranged along a first direction in a parallel plane which is parallel to the outgoing surface, each prism extending along a second direction which is orthogonal to the first direction, the at least one supporting body extending along the first direction.

In accordance with the light guide plate of Item 4, there is provided a variation of the light guide plate.

### [Item 5]

The light guide plate of Item 1 or 2, wherein, the at least one supporting body comprises a plurality of supporting bodies; and the plurality of supporting bodies are arranged in a dot pattern.

In accordance with the light guide plate of Item 5, there is provided a variation of the light guide plate.

### [Item 6]

The light guide plate of any of Items 1 to 5, wherein the prism reflection array has a plurality of first and a plurality of second slope surfaces inclined with respect to the outgoing surface, the plurality of first slope surfaces being coated with semi-reflective films which partially reflect a light beam propagating inside the light-guiding layer and which also partially transmit the light beam, the plurality of second slope surfaces not being coated with any semi-reflective films.

With the light guide plate of Item 6, propagating light inside the light guide plate is allowed to exit in the normal direction of the outgoing surface.

### [Item 7]

The light guide plate of Item 5, wherein each of the plurality of supporting bodies is dome-shaped.

In accordance with the light guide plate of Item 7, there is provided a variation of the supporting bodies.

### [Item 8]

The light guide plate of any of Items 1 to 7, wherein the first light-guiding layer includes the at least one supporting body together with the prism reflection array.

In accordance with the light guide plate of Item 8, by forming the prism reflection array and the at least one supporting body in the same light-guiding layer, production steps can be simplified.

### [Item 9]

The light guide plate of any of Items 1 to 7, wherein the light-guiding layer further has a third light-guiding layer that includes the at least one supporting body.

In accordance with the light guide plate of Item 9, a third light-guiding layer can be produced as an independent member.

### [Item 10]

The light guide plate of any of Items 1 to 7, wherein the at least one supporting body and the prism reflection array are formed as an integral piece.

In accordance with the light guide plate of Item 10, by forming the prism reflection array and the at least one supporting body in the same light-guiding layer, production steps can be simplified.

### [Item 11]

The light guide plate of any of Items 1 to 7, wherein the at least one supporting body is formed independently from the prism reflection array.

In accordance with the light guide plate of Item 11, a third light-guiding layer can be produced as an independent member.

### [Item 12]

The light guide plate of any of Items 1 to 11, wherein the at least one supporting body comprises a plurality of spacers defining a thickness of the light-guiding layer along the normal direction.

With the light guide plate of Item 12, supporting bodies can be easily provided in the light-guiding layer.

### [Item 13]

The light guide plate of any of Items 1 to 12, wherein the second light-guiding layer has an essentially flat surface.

With the light guide plate of Item 13, producibility of light guide plates can be provided.

### [Item 14]

The light guide plate of any of Items 1 to 13, further comprising a first transparent substrate supporting the first light-guiding layer and a second transparent substrate supporting the second light-guiding layer.

With the light guide plate of Item 14, the strength and durability of a light guide plate can be enhanced.

### [Item 15]

A lightguide comprising: a coupling structure having a light-receiving surface to receive a light beam from a display element; and the light guide plate of any of Items 1 to 14.

In accordance with the lightguide of Item 15, there is provided a lightguide incorporating a light guide plate which can reduce scattering of light inside the light guide plate and which can thus reduce blurring of virtual images to be projected onto a viewer's eye.

### [Item 16]

A virtual image display apparatus comprising:

a display element;

a collimating optical system to collimate displaying light emitted from the display element; and

the lightguide of Item 15.

In accordance with the lightguide of Item 16, there is provided a virtual image display apparatus that comprises a lightguide incorporating a light guide plate which can reduce scattering of light inside the light guide plate and which can thus reduce blurring of virtual images to be projected onto a viewer's eye.

### INDUSTRIAL APPLICABILITY

A light guide plate and a lightguide according to embodiments of the present invention are suitably applicable to an HMD, an HUD, or any other virtual image display apparatus or the like.

### INCORPORATION BY REFERENCE

The present application claims priority to Japanese Patent Application No. 2015-236221, filed on Dec. 3, 2015, the entire disclosure of which is incorporated herein by reference.

### REFERENCE SIGNS LIST

10 display element
20 projection lens system
30, 30A, 30B light guide plate
32 coupling structure
33 light-guiding layer
33A first light-guiding layer
33B second light-guiding layer
34A first transparent substrate
34B second transparent substrate
35 prism reflection array
35A optical prism
35B parallel surface
35C supporting prism
35D first slope surface
35E second slope surface
35r semi-reflective film
40 virtual image projection device
50 mask
100 virtual image display apparatus

1. A light guide plate comprising:
a light-guiding layer having a first light-guiding layer, the first light-guiding layer including a prism reflection array which is constructed so as to partially transmit a light beam propagating therein, and a second light-guiding layer covering the prism reflection array;
an outgoing surface via which the light beam transmitted through the prism reflection array is allowed to exit; and
at least one supporting body having, along a normal direction of the outgoing surface, a height which is greater than a height of the prism reflection array.

2. The light guide plate of claim 1, wherein the at least one supporting body is disposed in surroundings of the prism reflection array.

3. The light guide plate of claim 1, wherein the prism reflection array has a plurality of prisms arranged along a first direction in a plane which is parallel to the outgoing surface, each prism extending along a second direction which is orthogonal to the first direction, the at least one supporting body extending along the second direction.

4. The light guide plate of claim 1, wherein the prism reflection array has a plurality of prisms arranged along a first direction in a parallel plane which is parallel to the outgoing surface, each prism extending along a second direction which is orthogonal to the first direction, the at least one supporting body extending along the first direction.

5. The light guide plate of claim 1, wherein,
the at least one supporting body comprises a plurality of supporting bodies; and
the plurality of supporting bodies are arranged in a dot pattern.

6. The light guide plate of claim 1, wherein the prism reflection array has a plurality of first and a plurality of second slope surfaces inclined with respect to the outgoing surface, the plurality of first slope surfaces being coated with semi-reflective films which partially reflect a light beam propagating inside the light-guiding layer and which also partially transmit the light beam, the plurality of second slope surfaces not being coated with any semi-reflective films.

7. The light guide plate of claim 5, wherein each of the plurality of supporting bodies is dome-shaped.

8. The light guide plate of claim 1, wherein the first light-guiding layer includes the at least one supporting body together with the prism reflection array.

9. The light guide plate of claim 1, wherein the light-guiding layer further has a third light-guiding layer that includes the at least one supporting body.

10. The light guide plate of claim 1, wherein the at least one supporting body and the prism reflection array are formed as an integral piece.

11. The light guide plate of claim 1, wherein the at least one supporting body is formed independently from the prism reflection array.

12. The light guide plate of claim 1, wherein the at least one supporting body comprises a plurality of spacers defining a thickness of the light-guiding layer along the normal direction.

13. The light guide plate of claim 1, wherein the second light-guiding layer has an essentially flat surface.

14. The light guide plate of claim 1, further comprising a first transparent substrate supporting the first light-guiding layer and a second transparent substrate supporting the second light-guiding layer.

15. A lightguide comprising:
a coupling structure having a light-receiving surface to receive a light beam from a display element; and
the light guide plate of claim 1.

16. A virtual image display apparatus comprising:
a display element;
a collimating optical system to collimate displaying light emitted from the display element; and
the lightguide of claim 15.
